(19) United States
(12) Patent Application Publication
(10) Pub. No.: US 2008/0191622 A1
(43) Pub. Date: Aug. 14, 2008

(54) COLD CATHODE FLUORESCENT LAMP

(76) Inventors: Xi Kan, Hangzhou (CN); Yongjian Cai, Hangzhou (CN)

Correspondence Address: BYIP, LTD., P.O. BOX 1484, GENERAL POST OFFICE, HONG KONG, omitted

(21) Appl. No.: 12/014,112

(22) Filed: Jan. 15, 2008

(30) Foreign Application Priority Data
Feb. 13, 2007 (CN) 200720106531.4

(51) Int. Cl. H01J 17/24; H01J 61/12

(52) U.S. Cl. 313/558; 313/637

(57) ABSTRACT

A cold cathode fluorescent lamp includes a lamp base and a light tube coupled to the lamp base. The light tube includes a light tube body having two end portions, and a getter mercury dispensing electrode sealed into each end portion. The light tube body has a relatively large diameter of about 4 mm to about 10 mm, and the getter mercury dispensing electrode has a dimension configured to fit inside the light tube body.

### CROSS-REFERENCE TO RELATED APPLICATION

This application claims priority of Chinese Patent Application No. 200720106531.4 filed on Feb. 13, 2007.

FIELD OF APPLICATION

The present application generally relates to a cold cathode fluorescent lamp, and particularly to a light tube of a cold cathode fluorescent lamp.

BACKGROUND

Cold cathode fluorescent lamps are well known and have been used in a variety of fields such as Liquid crystal displays, neon signs, picture frame displays, automobile instrument boards, and scanners because of their small tube size, high luminous intensity, and uniform luminous emittance.

Conventional cold cathode fluorescent lamps include a light tube having a diameter of less than 4 mm. An electrode and a getter mercury dispenser are disposed at each of the two ends of the light tube. Under the requirement of achieving a lifetime of 20,000 hours, these small electrodes in light tubes of small diameter can only result in low power due to technical constraints. Furthermore, a light tube of small diameter is fragile.

A compact fluorescent lamp is another kind of conventional fluorescent lamp. This kind of lamp has a glass envelop 1 as shown in FIG. 1, which has a larger diameter than the above-mentioned conventional cold cathode fluorescent lamp, and is filled with one or more rare gases, such as argon or neon, and some mercury. There are two heat electrodes 2 for triggering and maintaining an electric discharge which causes luminous emission. The heat electrodes 2 are in the form of metal filaments disposed at the two ends of the glass envelop 1. This kind of lamp has a short lifetime and is not suitable for use in places where lamp needs to be switched on and off and the brightness needs to be adjusted frequently.

The above description of the background of the cold cathode fluorescent lamp is provided to aid in understanding the cold cathode fluorescent lamp disclosed in the present, application, but is not admitted to describe or constitute prior art to the cold cathode fluorescent lamp disclosed in the present application.

### SUMMARY

The present application is directed to a cold cathode fluorescent lamp. The cold cathode fluorescent lamp includes a lamp base and a light tube coupled to the lamp base. The light tube includes a light tube body having two end portions, and a getter mercury dispensing electrode sealed into each end portion. The light tube body has a relatively large diameter of about 4 mm to about 10 mm, and the getter mercury dispensing electrode has a dimension configured to fit inside the light tube body.

The present application is also directed to a light tube of a cold cathode fluorescent lamp. The light tube includes a light tube body having two end portions, and a getter mercury dispensing electrode sealed into each end portion. The light tube body has a relatively large diameter of about 4 mm to about 10 mm, and the getter mercury dispensing electrode has a dimension configured to fit inside the light tube body.

### BRIEF DESCRIPTION OF THE DRAWINGS

FIG. 1 is a side elevational view of a prior are light tube of an energy-saving fluorescent lamp of the prior art.

FIG. 2 is a side elevational view of a light tube of a cold cathode fluorescent lamp in accordance with an embodiment disclosed in the present application.

FIG. 3 is a perspective view of a getter mercury dispensing electrode in the form of a solid cylinder in accordance with an embodiment disclosed in the present application;

FIG. 4 is a perspective view of a getter mercury dispensing electrode in the form of two parallel spaced apart plates in accordance with another embodiment disclosed in the present application;

FIG. 5 is a side elevational view of a U-shaped light tube of a cold cathode fluorescent lamp in accordance with another embodiment disclosed in the present application; and

FIG. 6 is a side elevational view of a cold cathode fluorescent lamp having a light tube mounted on a lamp base.

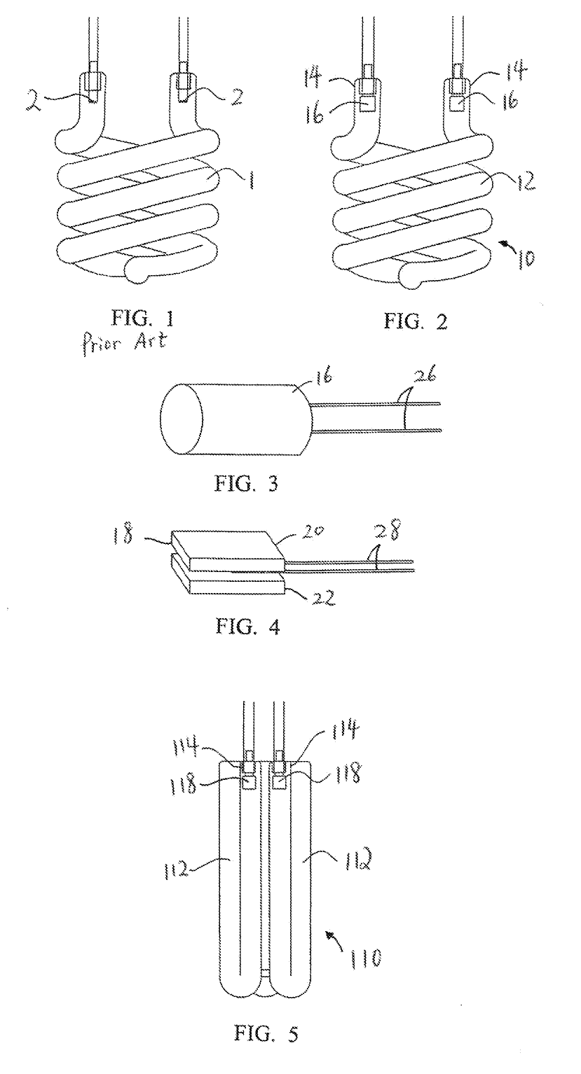

### DETAILED DESCRIPTION

It should be understood that the cold cathode fluorescent lamp disclosed in the present application is not limited to the precise embodiments described below and that various changes and modifications thereof may be effected by one skilled in the art without departing from the spirit or scope of the appended claims.

It should be noted that throughout the specification and claims herein, when one element is said to be “coupled” or “connected” to another, this does not necessarily mean that one element is fastened, secured, or otherwise attached to another element. Instead, the term “coupled” or “connected” means that one element is either connected directly or indirectly to another element or is in mechanical or electrical communication with another element.

As used, herein, the term “getter mercury dispensing electrode” means an electrode incorporated with a getter mercury dispenser to form a single unit.

FIG. 2 is a side elevational view of a light tube 10 of a cold cathode fluorescent lamp in accordance with an embodiment of the present application,

The light, tube 10 includes a helical light tube body 12 and two end portions 14, 14. Two getter mercury dispensing electrodes 16, 16 are sealed into the two end portions 14, 14 of the light tube 10 respectively. The inner surface of the light tube 10 is coated with fluorescent powders such as phosphors.

The light tube body 12 has a relatively large diameter of about 4 mm to about 10 mm, as compared to a conventional light tube body of a cold cathode fluorescent lamp having a relatively small diameter of less than about 4 mm. According to an embodiment of the present application, the diameter of the light tube body 12 is about 7 mm. The two getter mercury dispensing electrodes 16, 16 also have a relatively large surface area and dimension configured to fit into the two end portions 14, 14 of the light tube 10 respectively.

The light tube 10 is sealed at the two end portions 14, 14. The sealed light tube 10 is filled with one or more inert gases at a low pressure. The inert gases may be argon, neon, krypton, or a mixture thereof. The inert gases when excited by an electrical signal produce ultraviolet light, which in turn causes the coating of fluorescent powders to fluoresce, and to illuminate the environment.

The cold cathode fluorescent lamp, when used for example as a light source for backlighting of a liquid crystal display, may be configured such that cylindrical or plate metal is provided as the electrode in the light tube.

FIG. 3 is a perspective view of the getter mercury dispensing electrode 16 in accordance with an embodiment of the present application. The getter mercury dispensing electrode 16 is an electrode incorporated with a getter mercury dispenser to form a single unit. According to the illustrated embodiment, the getter mercury dispensing electrode 16 is in the form of a single unitary solid cylinder. The cylindrical getter mercury dispensing electrode 16 can be connected to two lead wires 26.

The getter mercury dispensing electrode 16 is composed of getter material and mercury material. The getter material provided on the getter mercury dispensing electrode 16 acts as a scavenger for removing unwanted gases inside the light tube 10. This improves the starting characteristics of the cold cathode fluorescent lamp and assists in lumen maintenance over the life of the lamp. The getter material may be a mixture or compound of aluminum, titanium, and zirconium.

The mercury material provided on the getter mercury dispensing electrode 16 may be a mixture or compound of mercury and titanium, or any other suitable mercury compounds. The getter and mercury materials may be formed on the getter mercury dispensing electrodes 16, 16, by any appropriate method such as coating or bonding. It is understood that the getter and mercury materials may be formed on any surfaces of the solid cylinder.

Although it has been shown the getter mercury dispensing electrode is cylindrical in shape, it is appreciated that the getter mercury dispensing electrode may be in other shapes.

FIG. 4 is a perspective view of a getter mercury dispensing electrode 18 in accordance with another embodiment of the present application. The getter mercury dispensing electrode 18 is in the form of two parallel spaced apart plates 20, 22. The getter mercury dispensing electrode 18 is connected to two lead wires 28. The getter mercury dispensing electrode 18 has a relatively large dimension, and the getter and mercury materials covering a relatively large surface area. It is understood that the getter and mercury materials may be formed on any surfaces of the two parallel spaced apart plates 20, 22.

Although it has been shown that the getter mercury dispensing electrode 16, 18 is in the shape of a solid cylinder or two parallel spaced apart plates. It is understood by one skilled in the art that the getter mercury dispensing electrode 16, 18 may be in other shapes having large surface areas. For example, the getter mercury dispensing electrode may be in the shape of a bowl, or three or more spaced apart plates.

FIG. 5 is a side elevational view of a U-shaped light tube 110 of a cold cathode fluorescent lamp in accordance with another embodiment of the present application.

The U-shaped light tube 110 includes a light tube body being bent into a plurality of U-shaped sections 112 and two end portions 114, 114. Two getter mercury dispensing electrodes 118, 118 are sealed into the two end portions 114, 114 of the light tube 110 respectively. The inner surface of the light tube 110 is coated, with phosphors.

Similar to the embodiment illustrated in FIG. 2, the light tube body of the U-shaped light tube 110 has a relatively large diameter of about 4 mm to about 10 mm, and the two getter mercury dispensing electrodes 118, 118 have a relatively large surface area and dimension configured to fit inside the two end portions 114, 114 of the light tube 110 respectively. The light tube 110 is sealed and filled with one or more inert gases at a low pressure. The getter mercury dispensing electrodes 118, 118 may be in the form of two parallel spaced apart plates, as shown in FIG. 4. It is contemplated that the getter mercury dispensing electrodes 118, 118 may be in the shape of a solid cylinder or other possible shapes.

Although it has been described that the U-shaped light tube 110 includes a light tube body being bent into a plurality of U-shaped sections 112, it is understood that the U-shaped light tube 110 may include only one U-shaped section.

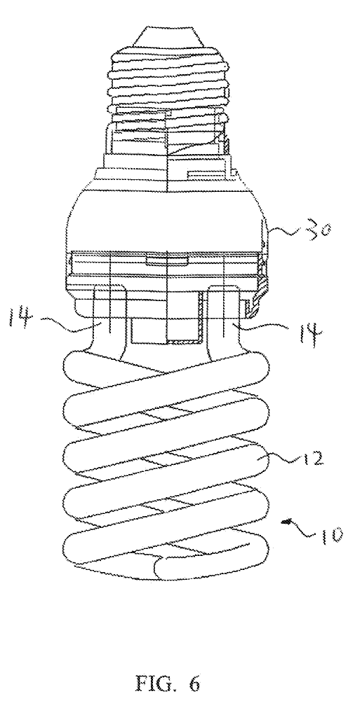

FIG. 6 is a side elevational view of a cold cathode fluorescent lamp having the light tube 10 mounted on a lamp base 30. The lamp base 30 may be an Edison Screw base or any other type of lamp base. The lamp can be connected to and powered by an integral ballast and/or a remote ballast, or similar power supplies.

The electrode of the cold cathode fluorescent lamp disclosed in the present, application has large surface area and is in the shape of a cylinder or spaced apart plates. The diameter of the light tube is relatively large, as compared to light tubes of conventional cold cathode fluorescent lamps.

The cold cathode fluorescent lamp disclosed in the present application overcomes the disadvantages of conventional lamps, such as low current, high voltage, low power and fragility, by larger tube diameter and larger getter mercury dispensing electrodes. Larger tube diameter can result in longer life up to 30,000 hours because discharge time and power consumption can be reduced. The cold cathode fluorescent lamp disclosed in the present application is also agleam and energy-saving. The energy consumed by a cold cathode fluorescent lamp is about 4 to 5 times less than a conventional lamp. Further, the times of on and off switching of the cold cathode fluorescent lamp is over a million during the life of the lamp.

The cold cathode fluorescent lamp disclosed in the present application can be used widely in places where frequent on and off switching, longevity of service or adjustable lighting is required. For example, the cold cathode fluorescent lamp disclosed in the present application can be used as flash lights in a square, adjustable bed lamps in a hotel, reading lights, droplights in a hall, and lamps in places where lighting is difficult to be reached and replaced.

While the cold cathode fluorescent lamp disclosed in the present application has been shown and described with particular references to a number of preferred embodiments thereof, it should be noted that various other changes or modifications may be made without departing from the scope of the appended claims.

What is claimed is:

1. A light tube of a cold cathode fluorescent lamp, comprising:
(a) a light tube body comprising two end portions and a diameter of about 4 mm to about 10 mm; and
(b) a getter mercury dispensing electrode sealed into each end portion, the getter mercury dispensing electrode comprising a dimension configured to fit inside the light tube body.

2. The light tube as claimed in claim 1, wherein the diameter of the light tube body is about 7 mm.

3. The light tube as claimed in claim 1, wherein the getter mercury dispensing electrode is in the form of a single unitary solid cylinder.

4. The light tube as claimed in claim 1, wherein the getter mercury dispensing electrode is in the form of two parallel spaced apart plates.

5. The light tube as claimed in claim 1, wherein the getter mercury dispensing electrode comprises getter and mercury materials.

6. The light tube as claimed in claim 1, wherein the light, tube body is filled with inert gases, and the inner surface of the light tube body is coated with phosphors.

7. The light tube as claimed in claim 1, wherein the light tube body is helical in shape.

8. The light tube as claimed in claim 1, wherein the light tube body comprises at least one U-shaped section.

9. The light tube as claimed in claim 1, wherein the getter mercury dispensing electrode is connected to two lead wires.

10. A cold cathode fluorescent lamp comprising:
(a) a lamp base;
(b) a light tube coupled to the lamp base, the light tube comprising a light tube body comprising two end portions and a diameter of about 4 mm to about 10 mm; and
(c) a getter mercury dispensing electrode sealed into each end portion and comprising a dimension configured to fit inside the light tube body.

11. The cold cathode fluorescent lamp as claimed in claim 10, wherein the diameter of the light tube body is about 7 mm.

12. The cold cathode fluorescent lamp as claimed in claim 10, wherein the getter mercury dispensing electrode is in the form of a single unitary solid cylinder.

13. The cold cathode fluorescent lamp as claimed in claim 10, wherein the getter mercury dispensing electrode is in the form of two parallel spaced apart plates.

14. The cold cathode fluorescent lamp as claimed in claim 10, wherein the getter mercury dispensing electrode comprises getter and mercury materials.

15. The cold cathode fluorescent lamp as claimed in claim 10, wherein the light tube body is filled with inert gases, and the inner surface of the light tube body is coated with phosphors.

16. The cold cathode fluorescent lamp as claimed in claim 10, wherein the light tube body is helical in shape.

17. The cold cathode fluorescent lamp as claimed in claim 10, wherein the light tube body comprises at least one U-shaped section.

18. The cold cathode fluorescent lamp as claimed in claim 10, wherein the getter mercury dispensing electrode is connected to two lead wires.

19. A cold cathode fluorescent lamp comprising:
(a) a lamp base;
(b) a light tube coupled to the lamp base, the light tube comprising a light tube body comprising two end portions and a diameter of about 4 mm to about 10 nun, the light, tube body filled with inert gases, and the inner surface of the light tube body coated with phosphors; and
(c) a getter mercury dispensing electrode sealed into each end portion and comprising a dimension configured to fit inside the light tube body, and the getter mercury dispensing electrode connected to two lead wires.
